(19) United States
(12) Patent Application Publication
(10) Pub. No.: US 2025/0377031 A1
(43) Pub. Date: Dec. 11, 2025

(54) PLASTICS GUIDED SPRING ROD AND BISTABLE MECHANISM COMPRISING SUCH A ROD

(71) Applicant: LATECOERE, Toulouse (FR)

(72) Inventors: Sébastien DEVILLEZ, SAINT JEAN (FR); Fabien LOUVEL, Mons (FR); Olivier QUENARD, Sainte Foy DAigrefeuille (FR)

(73) Assignee: LATECOERE, Toulouse (FR)

(21) Appl. No.: 18/875,226

(22) PCT Filed: Jun. 6, 2023
(86) PCT No.: PCT/EP2023/065120

§ 371 Date: Dec. 16, 2024

(30) Foreign Application Priority Data
Jun. 17, 2022 (FR) FR2205968

(51) Int. Cl. F16F 1/12; F16C 7/06

(52) U.S. Cl. CPC F16F 1/128; F16C 7/06

(57) ABSTRACT

Spring rod (1) having a compression spring (4) and two guiding tubes, a male tube (2) and a female tube (3), each having a cylindrical surface, a free end and a connecting end closed by a base (2c, 3c), the tubes being joined coaxially along a main axis (X) and suitable for sliding one inside the other. In addition, the tubes are made of plastics material and the bases (2c, 3c) delimit an internal space (INT) in which the compression spring (4) is positioned, this compression spring (4) bearing on the bases (2c, 3c).

### CROSS REFERENCE TO RELATED APPLICATION

This application is a national stage entry of PCT/EP2023/065120 filed Jun. 6, 2023, under the International Convention and claiming priority over French Patent Application No. FR2205968 filed Jun. 17, 2022

### TECHNICAL FIELD

The invention relates to a spring-loaded rod whose guiding system is made of plastic material. Such a spring-loaded rod is used as a connecting part in opening/closing or locking mechanisms to ensure that the mechanism remains in place even if the control chain breaks.

The invention also relates to a bistable mechanism in which one of the connecting parts is a spring-loaded rod with a plastic guiding system. In particular, vehicle doors—aircrafts, trains, ships—are intended to be operated by such a bistable mechanism.

Particularly in the aeronautical field, aircraft doors are opening devices actuated by bistable mechanisms and adapted to occupy two stable positions-open or closed.

### STATE OF THE ART

Generally speaking, a connecting rod is a mechanical part with an elongated body and a joint at each end. The connecting rod is traditionally used to transmit and transform one movement into another, or to change its amplitude. By adding a spring to the connecting rod body, it is possible to provide further transformations of the transmitted motion, the connecting rod body then consisting of two tubes fitted coaxially and adapted to slide one inside the other, forming the guiding system: such a spring-loaded connecting rod is particularly suitable for providing a “bistable” function in a mechanism.

A bistable mechanism is a mechanism for driving a part between two stable positions: when the part is in an intermediate position between these stable positions, it is then driven towards one or the other of these stable positions. According to a first example, an aircraft door may comprise a bistable actuation mechanism for which the stable positions are extreme positions of the door, i.e. in the closed position and in the open position. Under the action of this bistable mechanism, when the door is in a half-open intermediate position, it is driven either towards its closed position, or towards its open position. According to another example, also concerning aircraft doors, they can comprise a bistable locking mechanism equipped with a lever moving between a locking position and an unlocking position: when the lever is released between the locking position and the unlocking position, it switches to one or the other of these positions depending on the position it is in when it is released.

Bistable mechanisms are commonly produced by gas springs. However, the force produced by a gas spring depends on the behavior of its gas, whose physical properties, and therefore compression behavior, vary with temperature. In aeronautical applications, aircraft are subjected to wide temperature variations during use-which can vary from −40° C. to +70° C. during a single flight. What's more, a gas-operated actuator also includes a moving sealing gasket, the tightness of which is difficult to guarantee throughout the aircraft's operating life.

To overcome the disadvantages of gas-operated cylinders, spring-loaded connecting rods with a metal guide system are used in bistable mechanisms: spring-loaded connecting rods are more reliable because their mechanical properties vary very little over the operating temperature range, and they do not present sealing problems. However, such metal-guided spring-loaded connecting rods feature a spherical joint at each end to limit the risk of wear with the other parts of the bistable mechanism to which these spherical joints are connected.

In addition, the sliding of the push-in tubes of the connecting rod body produces undesirable friction, and metallic materials are susceptible to corrosion, both of which require coatings and/or surface treatments to ensure optimum operation of the spring-loaded connecting rod and the bistable mechanism. These drawbacks increase the complexity of manufacturing and installing the spring-loaded connecting rod with metal guide system, as well as the weight of the bistable mechanism.

### DESCRIPTION OF THE INVENTION

In order to overcome the above-mentioned drawbacks of the state of the art, the main aim of the invention is to improve the structure of a spring-loaded connecting rod and to produce a bistable mechanism that is mass-optimized and easier to install.

This choice of material simplifies the manufacture of the spring-loaded connecting rod, while eliminating the need for surface treatments which extend the manufacturing time and are likely to deteriorate over time.

More precisely, the object of the present invention is a spring-loaded rod comprising a compression spring and a guiding system consisting of two guiding tubes, a male tube and a female tube, each having a cylindrical surface, a free end and a connecting end comprising a member for connection to a shaft, the tubes being fitted coaxially along a main axis by their free end and suitable for sliding one inside the other along their facing cylindrical surfaces. The tubes are at least partly made of plastic material, and their connecting end is closed by a base having two faces perpendicular to the main axis-an inner face on each tube and an opposite outer face-these bases delimiting a space inside and a space outside the guide system. The compression spring, which is positioned in the inner space, comes to bear on the inner face of the base of each tube, while the connecting members, which are positioned in the outer space of the guide system, are connected to the outer faces of the tube bases.

Advantageously, a plastic guiding system has a lower density and therefore a lower mass than an equivalent metal guiding system, this mass decreases being particularly sought-after in the aeronautical world: indeed, a gain in mass means a lower consumption of combustible or the allocation of this gain in mass to another part of the aircraft. In addition, the structure of the guiding system has been simplified to two tubes, resulting in a faster manufacturing process and a structure that is more reliable over time.

Advantageously also, the compression spring, positioned inside the guiding system, is thus protected from external damage such as impacts and/or risks of corrosion.

According to preferred embodiments taken alone or in combination:
the connecting member comprises a block having a hole forming chamfers, of a suitable diameter which makes a ball-and-socket connection with the shaft;
the connecting member comprises a forked structure with branches extending on either side of the shaft;
the male and female tubes are made thick, from cylindrical surfaces facing each other, in different plastic materials to reduce friction between the two tubes, the materials being chosen in particular from nylon and high-density polyethylene;
the female tube has a translation stopping flange facing a cylindrical sleeve inserted between the cylindrical surfaces of the male and female tubes;
the sleeve is made from a sheet of polytetrafluoroethylene (PTFE) at least 1 mm thick, cut and then shaped into a cylinder;
the tubes have at least one circumferential groove facing the other tube, into which is inserted an annular stabilizing segment, preferably split to facilitate insertion, and/or made of an elastic material;
the circumferential grooves are close to the free ends of the tubes;
the segments are made of PTFE;
the tubes are of a length that makes the circumferential groove of the female tube accessible when the male tube is fully inserted into the female tube; and
at least one drainage hole is drilled in at least one of the guide tubes.

The invention also relates to a bistable mechanism comprising at least one plastic-guided spring-loaded connecting rod in the opening kinematics of an aircraft door.

### PRESENTATION OF FIGURES

Further features and advantages of the present invention will become apparent from the following detailed embodiment, without limiting the scope thereof, with reference to the appended figures, which show, respectively:

FIG. 1a shows a perspective view of a bistable mechanism in one of its stable positions;

FIG. 1b shows a perspective view of a bistable mechanism in another of its stable positions;

FIG. 2a is an assembledviewan example of a guiding spring rod in plastic according to the invention, used in the mechanism illustrated in FIG. 1a and FIG. 1b;

FIG. 2b an explode front view of an example of a guiding spring rod in plastic according to the invention, used in the mechanism illustrated in FIG. 1a and FIG. 1b;

FIG. 3 is a side view of the guiding spring rod in plastic in a first perpendicular orientation;

FIG. 4 a side view of the guiding spring rod in plastic in a second perpendicular orientations;

FIG. 5, a cross-sectional view of the guiding spring rod in plastic illustrated above and shown here in a first embodiment;

FIG. 6a is a cross-sectional view of the guiding spring rod in plastic shown in FIG. 1a to FIG. 4, and presented here in a second embodiment;

FIG. 6b is an enlargement view of the guiding spring rod in plastic shown in FIG. 1a to FIG. 4, and presented here in a second embodiment;

FIG. 7a is a cross-sectional view of the guiding spring rod in plastic shown in FIG. 1a to FIG. 4, and presented here in a third embodiment;

FIG. 7b is an enlargement view of the guiding spring rod in plastic shown in FIG. 1a to FIG. 4, and presented here in a third embodiment;

FIG. 8, a diagram of the direct ball-and-socket joint between the chamfer-forming hole in the connecting rod tube and the main axle, and

FIG. 9 shows a cross-sectional diagram of a variant of the fork connector.

### DETAILED DESCRIPTION

In the figures, identical reference signs refer to the same element and to the corresponding passages in the description.

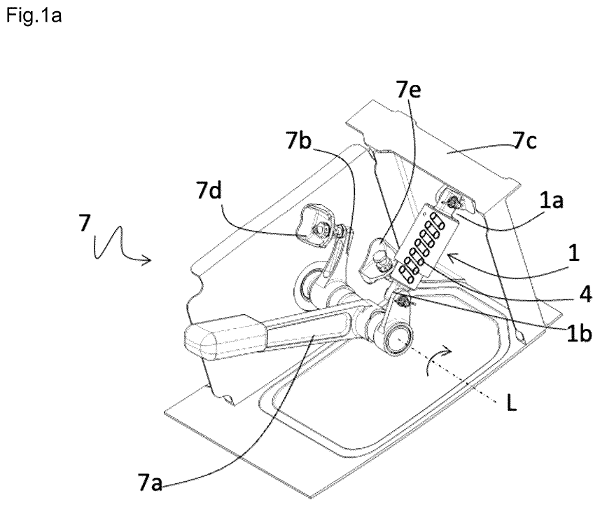

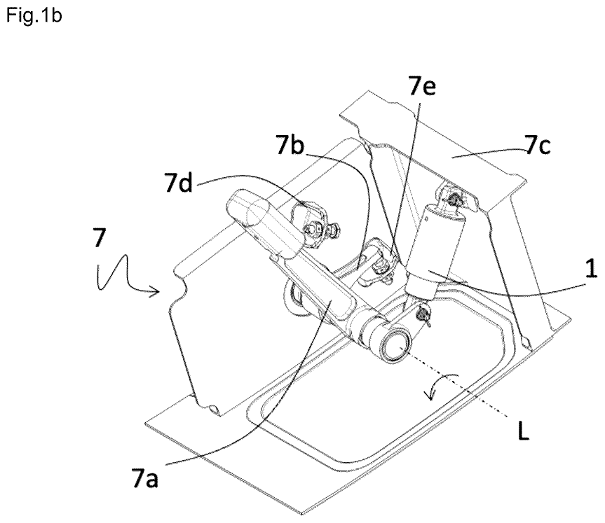

FIGS. 1a and 1b show an example of a bistable mechanism 7 according to the invention in its two stable positions. This bistable mechanism comprises a guiding spring rod 1 in plastic used to open an aircraft door (not shown). This spring rod 1 is connected by one of its ends 1a to a frame 7c belonging to the aircraft structure and, by its other end 1b, to a control lever 7a which can be positioned in two stable positions illustrated in FIGS. 1a and 1b respectively.

When an operator actuates the control lever 7a from a position illustrated in FIG. 1a or FIG. 1b, it rotates about its lever axis L, causing compression of the spring 4 (visible through transparency) of the spring rod 1, as well as rotation of the spring rod 1 relative to the frame 7c. In the case of a bistable mechanism, the operator will operate the control lever 7a to compress the spring 4.

When the operator releases control lever 7a, the spring 4 exerts its restoring force and drives control lever 7a back to its initial position: this position is therefore referred to as stable. If the operator continues to actuate control lever 7a, the spring rod 1 will pivot until it reaches a toggle position in which its ends 1a, 1b are aligned with lever axis L: in this position, spring 4 is compressed. This toggle position, intermediate between the two stable positions, is said to be unstable, since as soon as the spring rod 1 tilts out of this toggle position, spring 4 does not spontaneously return the spring rod 1 to this toggle position. As the spring 4 is compressed, it will try to extend and pull the spring 1 towards the stable position on the side where the connecting rod has tilted.

Thanks to this bistable mechanism 7, the control lever 7a has two stable positions: advantageously, this control lever 7a is integral with a lever 7b which is also movable between two positions and, in this example, actuates the kinematics for opening an aircraft door. The positions of lever 7b are shown here by stops 7d and 7e.

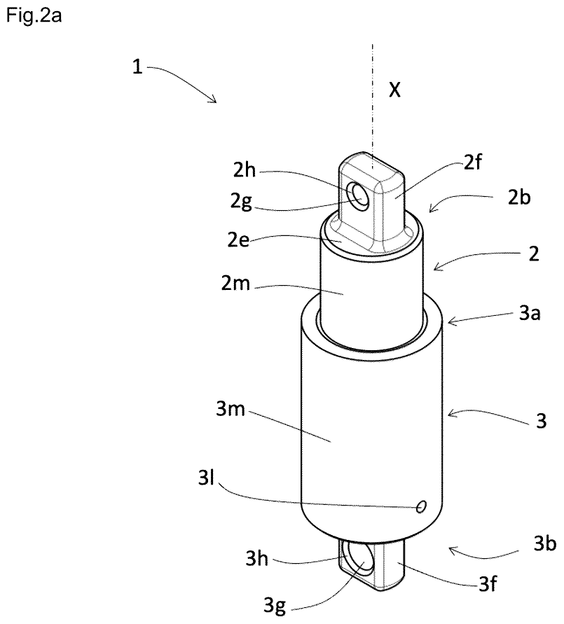

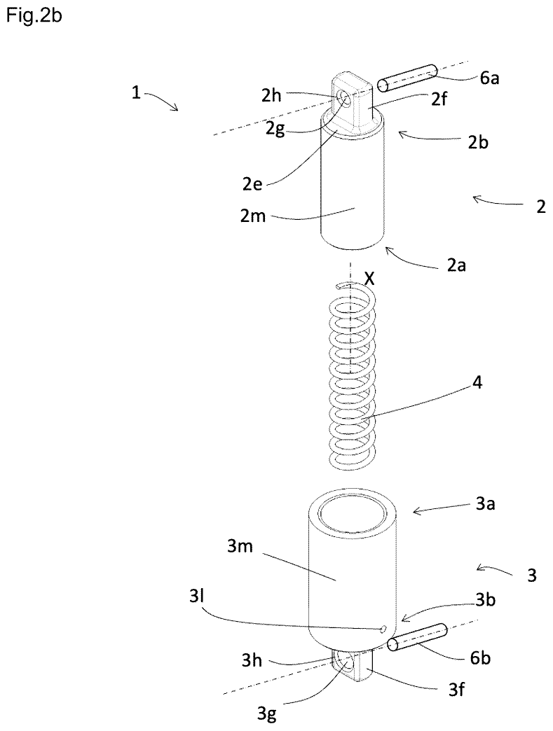

FIG. 2a and FIG. 2b show a perspective view, assembled and exploded respectively, of the spring rod 1 used in the previous mechanism. This spring rod 1 comprises the compression spring 4 and a guiding system consisting of two guiding tubes: a male tube 2 and a female tube 3. Each of the tubes 2, 3 has a cylindrical surface 2m, 3m, a free end 2a, 3a and a connecting end 2b, 3b comprising a member 2f , 3f for connection to a shaft 6a, 6b.

The male 2 and female 3 tubes are fitted coaxially along a main axis X by their free ends 2a, 3a and suitable for sliding one inside the other along their facing cylindrical surfaces 2m, 3m. In this embodiment, the connecting members 2f, 3f comprise a block having a through hole 2g, 3g and forming chamfers 2h, 3h. A drainage hole 31 is also drilled in the female tube 3: this drainage hole 31 allows fluids that may have entered the spring rod 1 to be drained off, and also facilitates air pressure equilibration between the inside and outside of the spring rod 1.

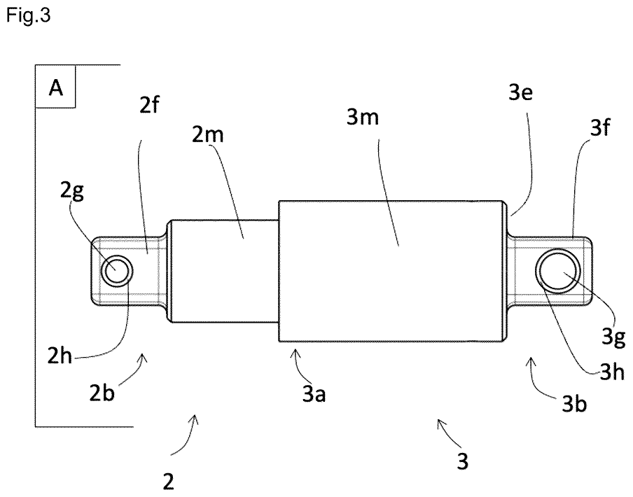

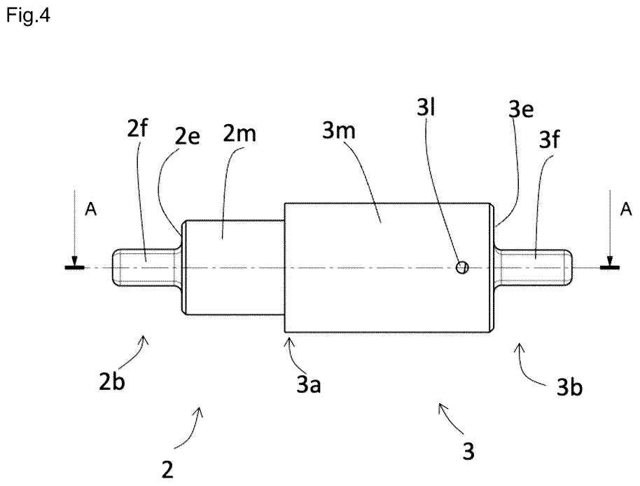

Side views of the spring rod 1 are shown in plane A in FIG. 3 and perpendicular to plane A in FIG. 4. In this embodiment, the drainage hole 31 is in plane A as shown in FIG. 4. When the spring rod 1 is mounted in the mechanism, this drainage hole 31 is positioned “vertically”, allowing natural flow and evacuation of fluids trapped in the spring rod 1.

FIG. 5 shows a cross-sectional view of the spring rod 1 in a first embodiment in which the cylindrical surfaces 2m, 3m of the male tube 2 and female tube 3 respectively are in direct contact: these tubes 2, 3 are then made thicker, from the cylindrical surfaces 2m, 3m facing each other, in different plastic materials, nylon for the male tube 2 and high-density polyethylene for the female tube 3 in this example, to reduce friction between the tubes. By limiting friction, sliding between the tubes is facilitated: by offering less resistance, the minimum return force of spring 4 is reduced, enabling a spring 4 of lower mass to be used. In addition, heating of the spring rod 1 is also reduced when the friction between tubes 2 and 3 is decreased.

For the purposes of this invention, the connecting ends 2b, 3b are closed by a base 2c, 3c with two faces perpendicular to the main axis X-an inner face 2d, 3dof each tube 2, 3 and an opposite outer face 2e, 3e—these bases 2c, 3c delimiting an inner space INT and an outer space EXT of the guide system. The compression spring 4 is positioned in the inner space INT and rests on the inner face 2d, 3d of the end of each tube 2, 3. The connecting members 2b, 3b are positioned in the external space EXT of the guide system and connected to the external faces 2e, 3e of the base of the tubes 2, 3.

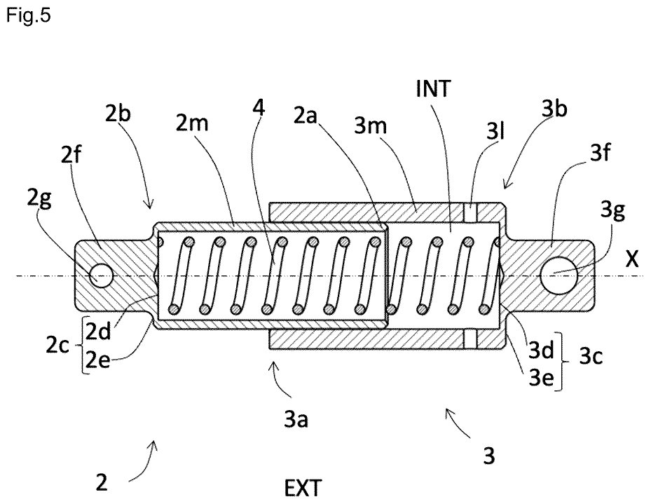

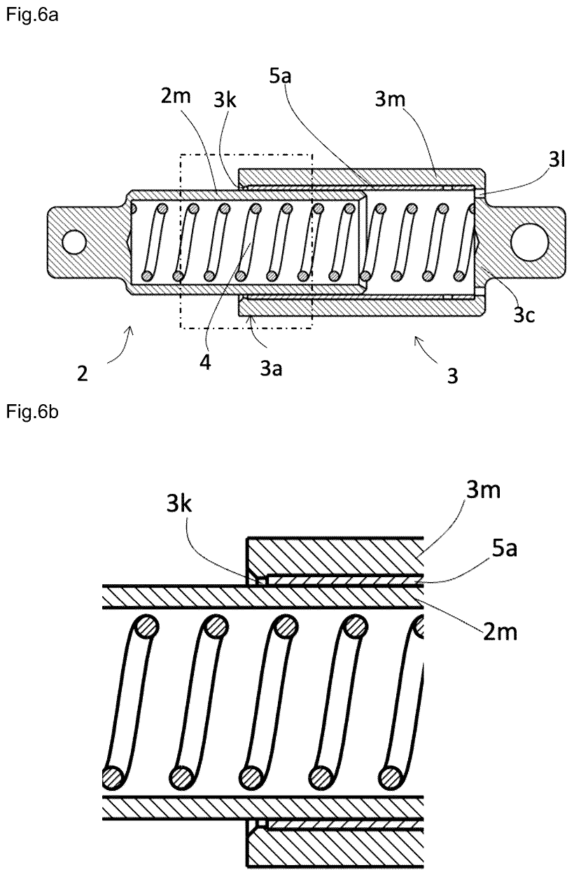

The sectional view in FIG. 6a shows the spring rod 1 in plane A according to a second design. In this embodiment, a cylindrical sleeve 5a is inserted between the cylindrical surfaces 2m, 3m of the male 2 and female 3 tubes. An enlarged view of the sleeve 5a is also shown in FIG. 6b. This sleeve 5a consists of a 1 mm-thick sheet of polytetrafluoroethylene (PTFE), which is cut and shaped into a cylinder before being inserted into the female tube 3. At its free end 3a, the female tube 3 has a flange 3k for stopping the cylindrical sleeve 5a in translation. This stopping flange 3k seals the interstitial space between the male tube 2 and the female tube 3, in which the cylindrical sleeve 5a is located.

In this example, male tube 2 and female tube 3 are separated by a cylindrical sleeve 5a, so there is no direct contact or friction between tubes 2 and 3, which can be made from the same plastic material. In addition, the drainage holes 31 are relocated on the base 3c of the female tube 3, the cylindrical surface 3m being completely covered by the cylindrical sleeve 5a.

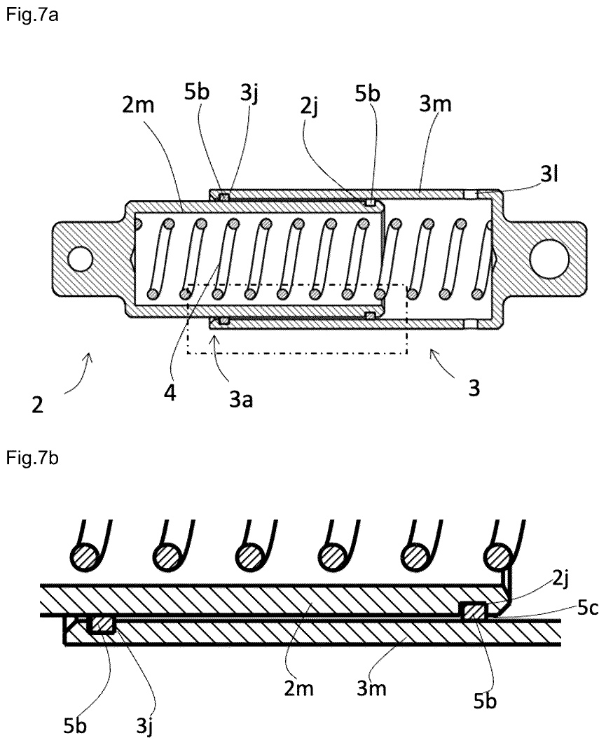

With reference to the cross-sectional view in FIG. 7a, a third design of the spring rod 1 is illustrated. In this embodiment, two annular interposing segments 5b are inserted between the tubes 2, 3 in order to make contact between the tubes 2, 3 and implement guiding. An enlarged view of the annular segments 5b is also shown in FIG. 7b. These annular interposing segments 5b are made of PTFE. Their purpose is to reduce friction between the male tube 2 and the female tube 3.

In addition, each tube 2, 3 has a circumferential groove 2j, 3j facing the other tube and located close to the free end 2a, 3a of each tube. In each circumferential groove 2j, 3j is inserted an annular interposing segment 5b. These annular interposing segments 5b are dimensioned to create an interstitial space 5c between the tubes 2, 3, which can thus be made of the same plastic material, this interstitial space 5c eliminating friction between the tubes 2, 3. Preferably, these annular interposing segments 5b are slotted in order to adapt their diameter and facilitate their insertion into the circumferential grooves 2j, 3j. Advantageously, these segments can be made of an elastic material. In this case, they may not be split.

Tubes 2, 3 are of a length that makes the circumferential groove 3j of the female tube 3 accessible when the male tube 2 is fully inserted into the female tube 3, compressing the compression spring 4 beyond its tipping point compression. The circumferential groove 3j thus accessible allows installation of an annular interposition segment 5b in the circumferential groove 3j. Preferably, compression spring 4 is compressed until the free end 2a of male tube 2 is in contact with the base 3c of female tube 3.

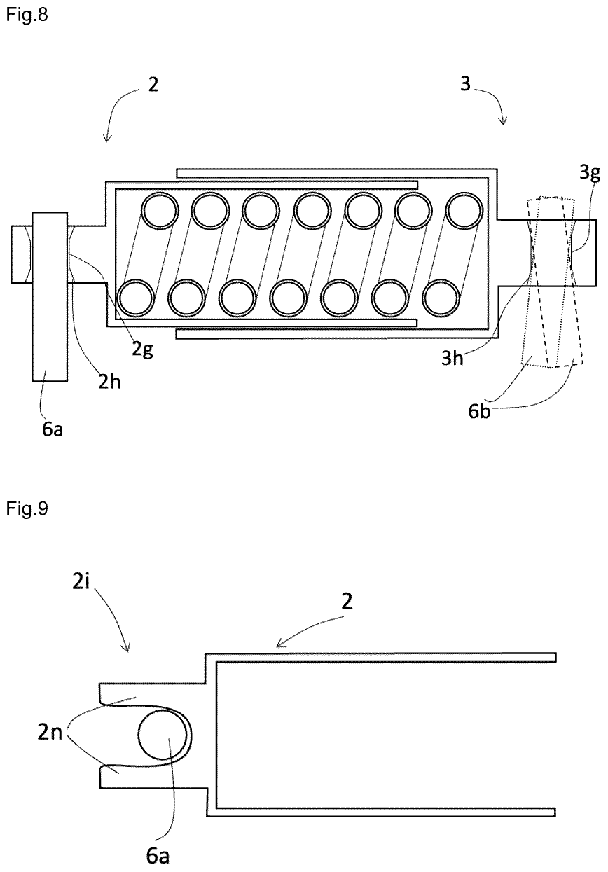

The diagram in FIG. 8 illustrates how the holes 2g, 3g forming the chamfers 2h, 3h of the connecting members 2f, 3f are connected by ball-and-socket joint: each through hole 2g, 3g has a diameter suitable for making a direct ball-and-socket joint with the shaft by means of the clearance allowed by the dimensions of the hole and chamfer 2h, 3h, without using an additional ball-and-socket joint part. In this diagram, the shaft 6a of the male tube 2 is shown fixed and the shaft 6b of the female tube 3 is shown in two orientations permitted by the direct ball-and-socket joint. This direct ball-and-socket joint makes for easy assembly of the spring rod 1, and provides a degree of freedom by eliminating the need for a ball-and-socket joint.

FIG. 9 shows a cross-sectional diagram of a fork-shaped variant 2i, shown here on connecting member 2f of male tube 2, but which can also be used on female tube 3. This fork 2i has two branches 2n extending on either side of the shaft 6a. This variant makes for easy assembly of the spring rod 1: the operator compresses the spring rod 1 to position it and then, when released, the spring locks the connecting rod in the mechanism. The fork connector can be combined with guide system versions featuring an interposed sleeve or ring segments.

The invention is not limited to the examples described and illustrated. The tubes can also be made of composite materials, particularly in the second and third embodiments with the interposed jacket or ring segments. A lubricating layer can also be inserted in the tubes to reduce friction.

Also in the third embodiment, each annular interposing segment can be composed of several juxtaposed and/or spaced sections, these sections forming a partial or complete ring.

In addition, the spring can be placed in the outer space, in which case the base of the tubes is adapted to provide support for the spring.

1. A spring rod (1) comprising:
a compression spring (4) and a guiding system consisting of two guiding tubes,
a male tube (2) and a female tube (3), each having a cylindrical surface (2m, 3m),
a free end (2a, 3a) and a connecting end (2b, 3b) comprising a connecting member (2f, 3f) for connection to a shaft (6a, 6b), the tubes (2, 3) being fitted coaxially along a main axis (X) by their free end (2a, 3a) and suitable for sliding one inside the other along their facing cylindrical surfaces (2m, 3m), the spring rod (1) being wherein the tubes (2, 3) are made at least partly of plastic material, their connecting end (2b, 3b) being closed by a base (2c, 3c) having two faces perpendicular to the main axis (X)—an inner face (2d, 3d) of each tube (2, 3) and an opposite outer face (2e, 3e)—these bases (2c, 3c) delimiting an inner space (INT) and an outer space (EXT) to the guiding system, and in that the compression spring (4), which is positioned in the inner space (INT), comes to bear on the inner face (2d, 3d) of the base (2c, 3c) of each tube (2, 3), while the connecting members (2f, 3f), which are positioned in the outer space (EXT) of the guide system, are connected to the outer faces (2e, 3e) of the base (2c, 3c) of the tubes (2, 3).

2. The spring rod (1) according to claim 1, wherein the connecting member (2f, 3f) has a hole (2g, 3g) forming chamfers (2h, 3h) of a suitable diameter which makes a ball-and-socket connection with the shaft (6a, 6b).

3. The spring rod (1) according to claim 1, wherein the connecting member (2f, 3f) comprises a fork-like structure (2i) whose branches (2n) extend on either side of the shaft (6a, 6b).

4. The spring rod (1) according to claims 1, wherein the male tube (2) and the female tube (3) are made thick, from cylindrical surfaces (2m, 3m) facing each other, of different plastic materials, the materials being chosen in particular from nylon and high-density polyethylene.

5. The spring rod (1) according to claim 1, wherein the female tube (3) has a translation stopping flange (3k) facing a cylindrical sleeve (5a) inserted between the cylindrical surfaces (2m, 3m) of the male (2) and female (3) tubes.

6. The spring rod (1) according to claim 5, wherein the sleeve (5a) consists of a sheet of polytetrafluoroethylene (PTFE) at least 1 mm thick, cut and then shaped into a cylinder.

7. The spring rod (1) according to claim 1, wherein the tubes (2, 3) have at least one circumferential groove (2j, 3j) facing the other tube (3, 2), into which a stabilizing ring segment (5b) is inserted.

8. The spring rod (1) according to claim 7, wherein the stabilizing ring segment (5b) is split and/or made of elastic material.

9. The spring rod (1) according to claim 7, wherein the circumferential grooves (2j, 3j) are close to the free end (2a, 3a) of the tubes.

10. The spring rod (1) according to claim 7, wherein the stabilizing ring segments (5b) are made of PTFE.

11. The spring rod (1) according to claims 7, wherein the tubes (2, 3) are of a length dimensioned to make the circumferential groove (3j) of the female tube (3) accessible when the male tube (2) is fully inserted into the female tube (3).

12. The spring rod (1) according to claim 1, wherein at least one drainage hole (31) is drilled in at least one of the guide tubes (2, 3).

13. A bistable mechanism (7) comprising at least one spring rod (1) in plastic according to claim 1.
